(19) United States
(12) Patent Application Publication
(10) Pub. No.: US 2016/0219912 A1
(43) Pub. Date: Aug. 4, 2016

(54) SELF BALANCING FOOD

(71) Applicant: New Universe Food LLC, Lake Forest, IL (US)

(72) Inventor: Sheehyung Sung, Lake Forest, IL (US)

(21) Appl. No.: 15/001,061

(22) Filed: Jan. 19, 2016

Related U.S. Application Data
(60) Provisional application No. 62/105,577, filed on Jan. 20, 2015.

(51) Int. Cl. A23L 1/29

(52) U.S. Cl. CPC A23L 1/296; A23L 1/1041; A23L 1/2001; A23L 1/2005; A23L 1/2121; A23L 1/2123; A23L 1/2142; A23V 2002/00

(57) ABSTRACT

The present subject matter relates to food products containing nutritional ingredients. The food products contain balanced nutrition to support a human body. The food products may support certain internal organs of a human body to be in balance. The combination of the ingredients may be chosen to support each of the Zang Fu organs. The food product may be balanced in terms of Yin and Yang, warming or cooling properties, the Five Elements, color, taste, or acidity. For example, the food products may contain a number of vegetables, grains, and beans. The ingredients may include some of broccoli, cabbage, spinach, tomato, sweet potato, carrot, onion, garlic, almond, and corn silk. The ingredients may include some of brown rice, barley, sorghum, adlay, black bean, millet, buckwheat, red bean, mung bean, oats, flax seed, and sesame seed.

### CROSS REFERENCE TO RELATED APPLICATION

The present application claims priority to U.S. Provisional Patent Application Ser. No. 62/105,577 filed Jan. 20, 2015, which is incorporated by reference in its entirety.

### FIELD OF INVENTION

The present subject matter relates to nutritional food products and specifically to food products with balanced nutrition, specifically designed to balance interworking of internal organs.

### BACKGROUND

It is difficult to consume sufficient, balanced nutrients one's body needs because of the lack of knowledge about nutritional facts or the difficulties in consuming set of foods that contains balanced nutrition. Even if people know the nutritional facts and can get food to meet recommended nutrition, the food may have high calories so people cannot consume enough nutrition. Alternatively, some people may not pay attention to the nutrition facts, thus not consuming the recommended level.

The lack of nutrition consumption required by internal organs can cause one's body to lose balance of internal operation and health and thus causes illness. Thus, eating balanced foods that provide full nutrient to internal organs can support one's body to gain and maintain balance and health.

### SUMMARY OF THE INVENTION

In some embodiments of the invention, food products and methods for preparing food products are provided. The food products contain ingredients with ample nutrition. For example, the food products may provide every nutrient a human body needs. The combination of the ingredients of the food products may be chosen to support each of the Zang Fu organs. The food products may be a meal replacement or a dietary supplement. The food product may be in a form of powder, bar, or liquid.

In some embodiments, the food product may contain ingredients that are balanced in terms of eastern medicine concepts. The eastern concepts may include at least one of yin and yang, the Five Elements, or warming and cooling properties. The food product may contain balanced ingredients in terms of color or taste. The food product may contain ingredients that are balanced in terms of at least one of chemical nutritional concepts or pH balance. The food product may contain ingredients that work in harmony to provide essential energy and required nutrients. In other embodiments, the food product may be balanced in a plurality of concepts.

In some embodiments, the food product may contain vegetables. The vegetables may include some of broccoli, cabbage, spinach, tomato, sweet potato, carrot, onion, garlic, almond, and corn silk. In further embodiments, the food product may contain all of the aforementioned ingredients. In other embodiments, the food product may contain grains. The grains may include some of brown rice, barley, sorghum, adlay, black bean, millet, buckwheat, red bean, mung bean, oats, flax seed, and sesame seed. In further embodiments, the food product may contain all of the aforementioned ingredients. In other embodiments, the food product may include some of the aforementioned ingredients. In other embodiments, the food product may include both vegetables and grains. In further embodiments, the food product may include all of the aforementioned ingredients.

Some of the further embodiments of the food product are provided. The food product may contain approximately equal amount of ingredients. Alternatively, the food product may contain different amounts of ingredients. For example, some of the ingredients may be approximately twice as much as other ingredients. The food product may contain an additive. The additive may be a preservative. The food product may contain seasoning. The seasoning may be salt or pepper. The food product may contain another nutritious element. The nutritious element may include nutribiotic ascorbic acid powder and natural salt.

In some embodiments, the food product may be supplementary to a meal. In other embodiments, the food product may be a replacement for a meal.

In some embodiments of the invention, the method of preparing the food product includes drying some ingredients. The ingredients may be vegetables, grains, or beans. The method may include washing and blanching vegetables and may include washing, soaking, sprouting, drying and roasting grains. The method may include grinding the dried ingredients to a powder form and may include mixing the dried ingredients. In some embodiments, the method includes compressing the food product into a bar form. In alternative embodiments, the method may include adding liquid. The method may also include mixing the liquid with the product in the powder form.

### BRIEF DESCRIPTION OF THE DRAWINGS

FIG. 1 illustrates an example package for a food product showing vegetable ingredients according to some embodiments.

FIG. 2 illustrates an example package for a food product showing grain and bean ingredients according to some embodiments.

FIG. 3 illustrates example nutritional values of ingredients for the vegetable product according to some embodiments.

FIG. 4 illustrates example nutritional values of ingredients for the grain and bean food product according to some embodiments.

FIG. 5 illustrates steps of preparing the vegetable food product according to some embodiments.

FIG. 6 illustrates steps of preparing the grain and bean food product according to some embodiments.

### DETAILED DESCRIPTION

The present subject matter relates to a nutritional food product. The food product may include a number of highly nutritional ingredients. The food product may provide sufficient, balanced nutrition and may support one's body to be in balance. The food product may be a meal replacement or a dietary supplement, and it can be, for example, in a form of powder, liquid, bar, or capsule.

The food product may be packed with nutrition that your body can easily absorb. The food product may improve digestion and bioavailability. The food product may improve circulation, which may be associated with reduction of pain and discomfort. The food product may help one's body feel better. The food product may provide proper nutrition helping people snack less, which in turn leads to weight loss. Because the sufficient amount of essential nutrients may be provided in a small quantity of food, people may eat smaller portions leading to longevity.

Eastern medicine defines the human body from a functional perspective. It focuses on the holistic view of a human body. In Eastern medicine, food is considered medicine. Eating a balanced meal allows people to be healthy and recover from illness. A balanced body will crave food that will maintain balance; an unbalanced body will crave food that will maintain imbalance. Therefore, balanced body is key to maintaining healthy interworking. In today's food culture, however, it may be difficult to get the right set of nutrients. According to some embodiments, the food product may include natural ingredients to provide important nutrition. For example, the nutrition may specifically target some or all of the Zang Fu organs. The Zang Fu organs are considered as the most important organs, and maintaining the wellbeing of these essential organs is the key to good health. Zang Fu includes five major (the spleen, the lungs, the kidneys, the liver, the heart) and six supporting organs (the stomach, the large intestine, the urinary bladder, the gallbladder, the small intestine, and the triple burner). Triple burner is not a physical organ and thus do not have a corresponding organ in western medicine. It is located throughout the internal parts of the body and includes heart, lungs, spleen, stomach, liver, kidneys, large intestine, small intestine, and bladder. Triple burner has a function of controlling the circulation of qi and body fluids. It is supported by numerous ingredients supporting other ogans. The food product of the present invention can balance the five major organs and the six supporting organs of the body. Alternatively, instead of or in addition to the Zang Fu organs, the food may target other organs or body parts.

The food product may contain balanced nutrition to support health. The ingredients may be balanced based on the Eastern medicine concept. For example, the food product may contain ingredients with balanced yin and yang. According to an embodiment of the present invention, the food product of the present invention can comprise the ingredients, where the combination of the ingredients has each of the yin and yang properties. The ingredients may be balanced in terms of the Five Elements: Fire, Earth, Metal, Water, and Wood. According to an embodiment of the present invention, the food product of the present invention can comprise the ingredients, where the combination of the ingredients has each of the Five Elements properties. The ingredients may be balanced in terms of color: red, yellow, white, black, and blue or taste: bitters, sweet, pungent, salty, and sour. The Five Elements, color, and taste may be associated with each other category and with the health of the Zang Fu organs, as provided in Table 1.

TABLE 1
Association of Five Elements and Other Characteristics

| Element | Taste | Color | Yin Organ | Yang Organ |
|---|---|---|---|---|
| Fire | Bitter | Red | Heart | Small Intestine |
| Earth | Sweet | Yellow | Spleen | Stomach |
| Metal | Pungent | White | Lungs | Large Intestine |
| Water | Salty | Black | Kidneys | Bladder |
| Wood | Sour | Blue | Liver | Gallbladder |

For example, according to eastern medicine concepts, an ingredient having the property of wood (e.g., spinach) tends to be sour and blue and to have health benefits to liver and gallbladder. Also, an ingredient having the property of water (e.g., black bean) tends to be salty and black and have health benefits to kidneys and bladder. Ingredients may have more than one property and may have different strength levels for the properties. Thus, different specialists of oriental medicine may categorize the property of ingredients differently.

The ingredients may be balanced in terms of other properties, as illustrated in Tables 2 and 3. For example, the ingredients may be balanced in terms of cooling and warming properties or in terms of pH. According to an embodiment of the present invention, the food product of the present invention can comprise the ingredients having each of the cooling and warming properties. According to another embodiment of the present invention, the food product of the present invention can comprises the ingredients having each of acidic or basic pH. Balanced ingredients may or may not mean that there is equal amount of ingredients of different properties. For example, human blood has a pH level of about 7.44, so a balanced food product may be slightly alkaline. The ingredients of the food may be balanced in terms of nutritional elements, e.g., carbohydrates, fat, protein, vitamins, and minerals. Because of the well-balanced nutrition, people may not need to consider what other nutrients or food to consume. The ingredients may be balanced in terms of one or more categories listed above in combination.

TABLE 2
Characteristics of Ingredients - Vegetables

| Ingredient | pH Type | Yin/Yang | Five Elements | Temperature |
|---|---|---|---|---|
| Almond | Alkaline | Yin | Metal | Cooling |
| Broccoli | Alkaline | Yang | Wood | N |
| Cabbage | Alkaline | Yin | Earth | Cooling |
| Carrot | Alkaline | Yang | Earth | Warming |
| Corn Silk | Acid | Yin | Water | Cooling |
| Garlic | Alkaline | Yang | Metal | Warming |
| Onion | Alkaline | Yang | Metal | Warming |
| Spinich | Alkaline | Yang | Wood | Warming |
| Sweet Potato | Alkaline | Yin | Earth | N |
| Tomato | Alkaline | Yang | Fire | Warming |

TABLE 3
Characteristics of Ingredients - Grains and Beans

| Ingredient | pH Type | Yin/Yang | Five Elements | Temperature |
|---|---|---|---|---|
| Job's Tears | Acid | Yin | Metal | Cooling |
| Barley | Acid | Yang | Earth | Warming |
| Black Bean | Acid | Yin | Water | N |
| Brown Rice | Alkaline | N | Metal | Warming |
| Buckwheat | Alkaline | Yin | Water | Cooling |
| Millet | Alkaline | Yang | Earth | Warming |
| Mung Bean | Alkaline | Yin | Wood | Cooling |
| Red bean | Acid | Yin | Water | Cooling |
| Sesame seed | Alkaline | Yang | Fire | Warming |
| Sorghum | Acid | Yang | Earth | Warming |
| Oats | Acid | Yang | Earth | Warming |
| Flax seed | Alkaline | N | Wood | N |

Some alternative ingredients are provided in Tables 4 and 5.

TABLE 4
Characteristics of Alternative Ingredients - Vegetables

| Ingredient | pH Type | Yin/Yang | Five Elements | Temperature |
|---|---|---|---|---|
| Beet | Alkaline | Yin | Fire | N |
| Bell Pepper | Alkaline | Yin | Fire | Warming |
| Cashew Nut | Acid | Yin | Wood | N |
| Cauli-flower | Alkaline | Yin | Metal | Cooling |
| Chestnut | Alkaline | Yang | Water | Warming |
| Chives | Alkaline | Yang | Metal | Warming |
| Ginger | Alkaline | Yang | Metal | Warming |
| Jujube (Date) | Alkaline | N | Metal | Warming |
| Kale | Alkaline | Yang | Water | Warming |
| Potato | Alkaline | Yang | Earth | Cooling |
| Pumpkin | Alkaline | N | Earth | Warming |
| Scallion | Alkaline | Yin | Fire | Warming |

TABLE 5
Characteristics of Alternative Ingredients - Grains and Beans

| Ingredient | pH Type | Yin/Yang | Five Elements | Temperature |
|---|---|---|---|---|
| Amaranth | Alkaline | Yang | Fire | |
| Chia seed | Alkaline | Yang | Water | |
| Chick Peas | Acid | Yang | Water | |
| Lentils | Acid | Yang | Fire | |
| Quinoa | Alkaline | Yang | Water | |
| Wheat | Acid | Yang | Wood | Warming |

The food product may provide the abundance of nutrition to help one's body regain or maintain balance. The balance of one's body can be based on either the eastern or chemical nutritional concepts or both as illustrated above. For example, eating self balancing food may assist one's body to have yin and yang balance, the Five Elemental balance, body heat balance, or pH balance. The food product may contain the necessary amount of nutrients that one's body needs without additional efforts to consider nutritional values. Therefore, people may not need to consider what other nutrients or food to consume.

The food product helps restore internal balance. Specifically, the food product helps restore the balance of internal organs (e.g., the Zang Fu organs). To balance the internal organs of a person regardless of the person's condition, it may be important to select the combination of ingredients that support each of the organs. For each of the internal organs, there may be at least one ingredient supporting it. For example, as illustrated in Table 6 and 7 below, a heart is supported by broccoli, tomato, almond, brown rice, sorghum, mung bean, and sesame seed; and a spleen is supported by millet, buckwheat, and oat; lungs are supported by spinach, sweet potato, carrot, onion, garlic, adlay, and millet; kidneys are supported by tomato, sorghum, black bean, and read bean; a liver is supported by cabbage, spinach, carrot, onion, garlic, almond, corn silk, millet, buckwheat, red bean, oat, flax seed, and mung bean; a small intestine is supported by brown rice and mung bean; a stomach is supported by broccoli, cabbage, sweet potato, carrot, onion, garlic, flax seed, and red bean; a large intestine is supported by brown rice and barley; a bladder is supported by corn silk, sorghum, and adlay; a gallbladder is supported by cabbage, spinach, carrot, onion, garlic, almond, corn silk, millet, buckwheat, red bean, oat, flax seed, and mung bean, which are the same ingredients that support liver. As illustrated above, a triple burner is supported by many of the ingredients.

Having too many ingredients may dilute the effects to promote each of the organs and thus may require a large level of consumption that is not practical. Having too few ingredients may not adequately support the organs. Having roughly ten vegetable ingredients and ten grain ingredients may be especially effective. But having about five more or fewer vegetable ingredients and five more or fewer grain ingredients may also be very effective.

The food product may be divided into two types: (1) grains and beans and (2) vegetables. Alternatively, they may be combined into one. Some ingredients may not strictly be categorized as grains or vegetables, but they are added to the classification for convenience. For example, almond and corn silk are not vegetables strictly speaking, but they are classified as vegetables herein.

According to Traditional Chinese Medicine, there are eight body types and each has its own nutritional needs. Taken the food product may allow each body type to regain its natural balance.

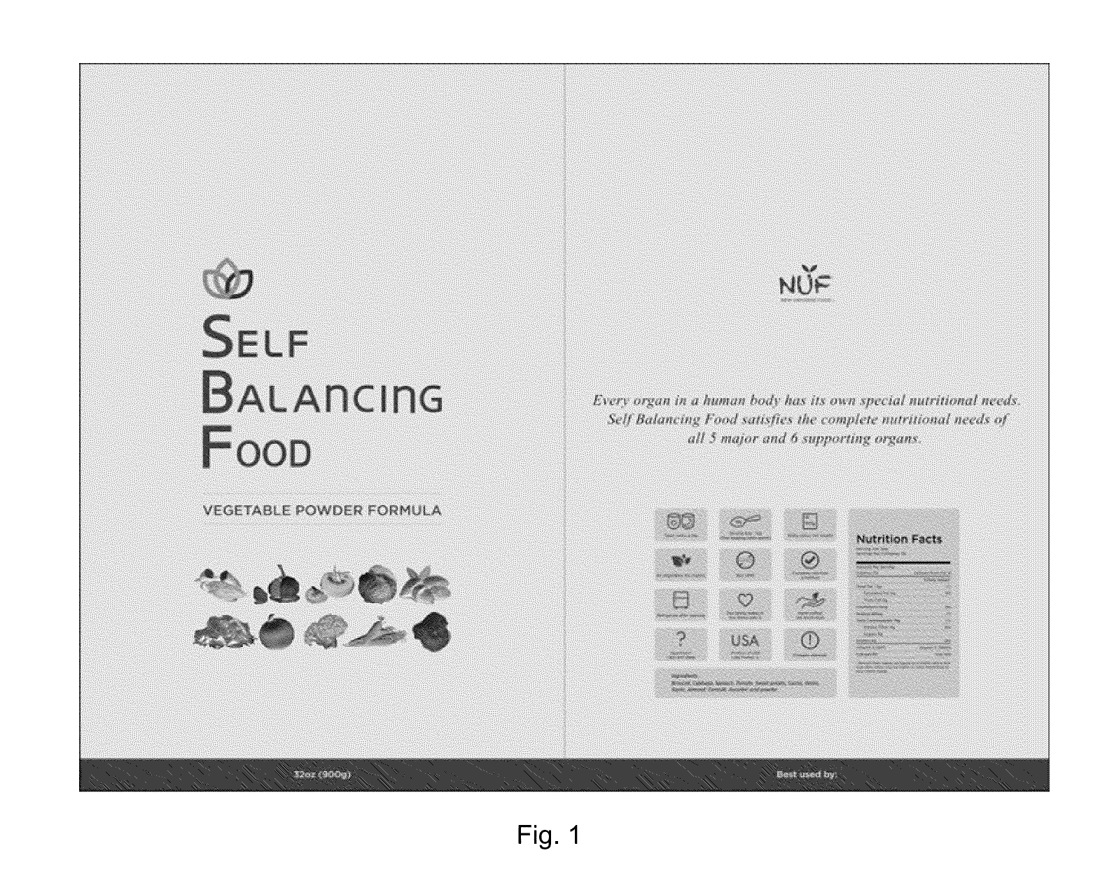

According to some embodiments, FIG. 1 illustrates a vegetable powder formula. For example, the ingredients may include one or more of broccoli, cabbage, spinach, tomato, sweet potato, carrot, onion, garlic, almond, or corn silk. The food product may also contain another nutritious element (e.g., nutribiotic ascorbic acid powder). Table 6 lists the ingredients mentioned above, a selected list of organs or body parts supported by each of the ingredients, and their health benefits. In addition to the organs listed in the second column, the ingredients may support other organs. The list of ingredients is for illustrative purposes, and some or all of the ingredients may be replaced by different ingredients or removed. Furthermore, the food product may or may not include all of the ingredients.

TABLE 6
Health Benefit of Self Balancing Food (Vegetable)

| Ingredients | Organs | Body Part | Health Benefits |
|---|---|---|---|
| Broccoli | Heart, stomach | Eyes, bone, brain | Reduce cholesterol level, improve |
| | | | immune system, improve eye health, |
| | | | skin (liver spots, freckles), slow aging, |
| | | | improve brain health. |
| | | | Reduce risk of, prevent, improve, or |
| | | | treat: cancer (e.g., breast and prostate |
| | | | cancers), heart disease, ulcers, anemia, |
| | | | respiratory diseases, Helicobacter pylori, |
| | | | osteoporosis, depression. |
| Cabbage | Stomach, liver, | Muscle, bone, | Protect gastric mucous membrane, |
| | gallbladder | skin | improve immune system, improve |
| | | | bowel movement. |
| | | | Reduce risk of, prevent, mitigate, or |
| | | | treat: cancer (e.g., colon cancer), |
| | | | inflammation, constipation, wrinkles, |
| | | | freckles, osteoporosis, fatty liver, |
| | | | hyperlipidemia, obesity. |
| Spinach | Liver, lungs, | Brain, bone, | Improve hematopoietic activity, improve |
| | gallbladder | teeth | blood circulation, improve eye health, |
| | | | improve digestion. |
| | | | Reduce risk of, prevent, mitigate, or |
| | | | treat: osteoporosis, anemia, dementia, |
| | | | cancer, constipation, hypertension. |
| Tomato | Heart, kidneys | Prostate, bone, | Lower high blood pressure, improve |
| | | skin | prostate health, slow aging, enhance |
| | | | antioxidant activity, promote male |
| | | | reproductive function, reduce fatigue, |
| | | | prevent obesity, reduce freckle. |
| | | | Reduce risk of, prevent, mitigate, or |
| | | | treat: cancer, arteriosclerosis, |
| | | | constipation, stroke, breast cancer, |
| | | | stomach cancer. |
| Sweet potato | Lungs, stomach | Skin, eyes | Lower high blood pressure, reduce |
| | | | obesity, enhance bowel movements, |
| | | | slow aging, improve skin, improve |
| | | | vision (e.g., night vision), enhance |
| | | | stamina, remove active oxygen. |
| | | | Reduce risk of, prevent, mitigate, or |
| | | | treat: constipation, fatty liver, cancer |
| | | | (e.g., colon cancer), obesity, edema. |
| Carrot | Lungs, liver, | Eyes, skin, bone, | Improve blood circulation, prevent hair |
| | stomach, | teeth | loss, improve immune system, reduce |
| | gallbladder | | fatigue, enhance stamina. |
| | | | Reduce risk of, prevent, mitigate, or |
| | | | treat: cancer, menstrual pain, cold hands |
| | | | and feet, hepatitis, Alzheimer's, |
| | | | depression. |
| Onion | Lungs, liver, | Eyes, skin, uterus | Lower high blood pressure, lower |
| | stomach, | | cholesterol, eliminate fat, reduce fatigue, |
| | gallbladder | | reduce obesity, improve immune |
| | | | system, slow aging, detox, reduce |
| | | | bacteria. |
| | | | Reduce risk of, prevent, mitigate, or |
| | | | treat: vascular disease, diabetes, cancer, |
| | | | cataracts, insomnia. |
| Garlic | Lungs, liver, | Skin, tumor | Improve immune system, sterilize |
| | stomach, | | germs, detox, lower high blood pressure, |
| | gallbladder | | enhance stamina, improve blood vessel |
| | | | function, slow aging, improve skin, |
| | | | improve digestion. |
| | | | Reduce risk of, prevent, mitigate, or |
| | | | treat: cancer, diabetes, constipation, |
| | | | nerve pain, muscle pain. |
| Almond | Heart, liver, | Brain, skin, bone | Reduce obesity, slow aging, enhance |
| | gallbladder | | brain development, improve |
| | | | concentration, enhance memory, reduce |
| | | | liver fatigue, detox, improve joint |
| | | | health. |
| | | | Reduce risk of, prevent, mitigate, or |
| | | | treat: cardiovascular disease, cancer, |
| | | | constipation, osteoporosis, dementia. |
| Corn silk | Liver, bladder, | teeth | Remove waste, detox, reduce body fat, |
| | gallbladder | | lower blood pressure, improve prostate |
| | | | health, reduce obesity, produce bile |
| | | | acids, quench thirst. |
| | | | Reduce risk of, prevent, mitigate, or |
| | | | treat: kidney disease, diuretic, swelling, |
| | | | toothache, diabetes, icterohepatitis, |
| | | | cardiovascular disease, sinusitis. |
| Vitamin C | Liver, | Eyes, skin | Recover from fatigue, improve immune |
| | gallbladder | | system, slow aging, improve skin, |
| | | | improve blood circulation, improve |
| | | | antioxidant activity, detox, improve liver |
| | | | health, improve gum health, improve |
| | | | colon health, strengthen adrenal |
| | | | function, enhance fracture recovery. |
| | | | Reduce risk of, prevent, mitigate, or |
| | | | treat: inflammatory disease, diabetes. |

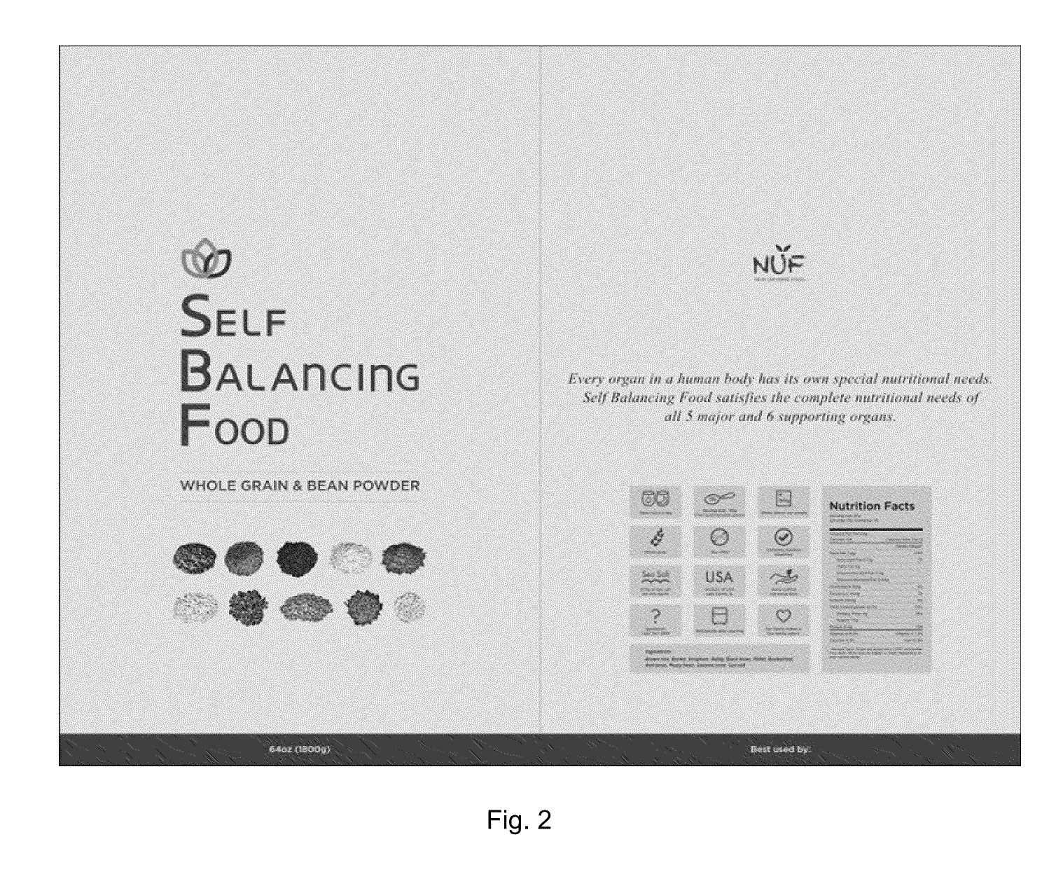

According to some embodiments, FIG. 2 illustrates a grain and bean formula. For example, the ingredients may include some of brown rice, barley, sorghum, adlay (or Job's tears), black bean, millet, buckwheat, red bean, mung bean, or sesame seed. The product may also include salt or other seasonings. Table 7 lists the ingredients mentioned above, a selected list of organs supported by each of the ingredients, and their health benefits. In addition to the organs listed in the second column, the ingredients may support other organs. The list of ingredients is for illustrative purposes and some or all of the ingredients may be replaced by different ingredients or removed. Furthermore, the food product may or may not include all of the ingredients.

TABLE 7
Health Benefit of Self Balancing Food (Grain and Bean)

| Ingredients | Organs | Health Benefits |
|---|---|---|
| Brown rice | Heart, intestine | Reduce risk of, prevent, mitigate, or treat: diabetes, chronic |
| | | constipation, high blood pressure, cholesterol, aging, |
| | | depression, cancer, kidney stone, obesity. |
| Barley | Large intestine, | Improve bone and teeth health, digestion, detox, slow aging. |
| | pancreas | Reduce risk of, prevent, mitigate, or treat: dyspepsia, |
| | | beriberi, diuretic, cancer, diabetes, constipation, obesity, |
| | | cholesterol. |
| Sorghum | Kidney, heart, | Improve brain health, reduce cholesterol level, improve |
| | bladder | digestion, improve immune system, improve skin condition. |
| | | Reduce risk of, prevent, mitigate, or treat: cystitis, anemia, |
| | | cancer, diabetes, diarrhea. |
| Adlay | Lungs, bladder | Remove waste, improve brain health, improve bowel |
| | | movement, improve skin. |
| | | Reduce risk of, prevent, mitigate, or treat: diuretic, asthma, |
| | | diabetes, hypertension, atherosclerosis, hyperlipidemia, |
| | | cancer, constipation. |
| Black bean | Kidney | Improve brain health, improve bone health, detox (e.g., |
| | | detox kidney and liver), slow aging, improve skin health. |
| | | Reduce risk of, prevent, mitigate, or treat: osteoporosis, |
| | | diabetes, cancer. |
| Millet | Liver, spleen, | Boost stamina, detox, improve digestion, improve bone |
| | lungs, | health, improve skin, slow aging. |
| | gallbladder | Reduce risk of, prevent, mitigate, or treat: cough, nausea, |
| | | osteoporosis, diarrhea, diuretic, edema, cancer, anemia. |
| Buckwheat | Spleen, liver, | Detox (e.g., detox liver), remove waste, improve skin, lower |
| | gallbladder | high blood pressure, tranquilize, improve antioxidant. |
| | | Reduce risk of, prevent, mitigate, or treat: diuretic, diabetes, |
| | | inflammation, arteriosclerosis. |
| Red bean | Liver, kidney, | Prevent hair loss, detox. |
| | stomach, | Reduce risk of, prevent, mitigate, or treat: edema, diuretic, |
| | gallbladder | inflammation, cancer, shortage of breast milk, diabetes, eye |
| | | fatigue, constipation. |
| Mung bean | Heart, liver, | Detox, reduce fever, tranquilize, improve antioxidant |
| | small intestine, | activity. |
| | gallbladder | Reduce risk of, prevent, mitigate, or treat: skin problems, |
| | | anemia, diabetes, diuretic. |
| Sesame seed | Heart, brain | Improve bone health, improve teeth health, enhance stamina, |
| | | detox liver, slow aging, improve immune system, lower high |
| | | blood pressure. |
| | | Reduce risk of, prevent, mitigate, or treat: anemia, cancer, |
| | | diabetes, chronic gastrointestinal disorder, arteriosclerosis, |
| | | constipation. |
| Oats | Spleen, liver, | Remove waste, reduce cholesterol level, improve bone |
| | gallbladder | health, improve skin condition, promote antioxidant activity, |
| | | improve immune system, promote diet. |
| | | Reduce risk of, prevent, mitigate, or treat: diabetes, |
| | | cardiovascular disease, constipation, hemorrhoids, cancer, |
| | | anemia. |
| Flax seed | Liver, stomach, | Improve brain health, improve skin condition, promote |
| | large intestine, | growth. |
| | gallbladder | Reduce risk of, prevent, mitigate, or treat: heart disease, |
| | | vascular disease, cancer, diabetes, constipation, female |
| | | disorders (e.g., menopause, breast cancer, osteoporosis), |
| | | prostate cancer, constipation. |

In some embodiments, the food product may contain approximately equal amount of ingredients. Alternatively, the food product may contain certain ingredients in larger amounts than others. For example, as illustrated in Table 8, the food product may contain twice as much broccoli, cabbage, corn silk, onion, spinach, sweet potato, tomato as almond, carrot, and garlic. In addition, ascorbic acid can be added approximately equal amount of the almond, carrot, and garlic. Table 8 shows the ratio based on weight in whole numbers, but the ratio may not be exact. Alternatively, the ratio may be different by a factor of two. For example, the food product may contain garlic as much as other ingredients of larger quantities. In other embodiments, the food product may contain different amounts of the ingredients.

TABLE 8
Ratio of Ingredients based on Weight (Vegetable)

| Ingredients | Ratio |
|---|---|
| Almond | 1 |
| Broccoli | 2 |
| Cabbage | 2 |
| Carrot | 1 |
| Corn Silk | 2 |
| Garlic | 1-2 |
| Onion | 2 |
| Spinach | 2 |
| Sweet Potato | 2 |
| Tomato | 2 |

According to an embodiment of the present invention, the food product of Table 8 has the chemical nutrition facts in Table 9. Table 9 shows the nutrition facts for 100 g. One serving size for the vegetable product is 30 g, so the nutrition facts for one serving size in Table 9 should be appropriately adjusted.

TABLE 9
Chemical Nutrition Facts of Vegetable Powder

| | |
|---|---|
| Calorie (kcal) | 350.9 |
| Carbohydrate (%) | 65.4 |
| Sugars (%) | 19.4 |
| Crude protein (%) | 16.7 |
| Crude fat (%) | 2.5 |
| Saturated fatty acid | 0.0 |
| (g/100 g) | |
| Trans fat (g/100 g) | 0.00 |
| Cholesterol (mg/100 g) | 1.5 |
| Sodium (mg/100 g) | 313.8 |
| Vitamin A (μg/100 g) | 26 |
| Vitamin B1 (mg/100 g) | 1.7 |
| Vitamin B2 (mg/100 g) | 0.5 |
| Vitamin B6 (mg/100 g) | 0.2 |
| Vitamin C (mg/100 g) | 18.4 |
| Vitamin E (mg/100 g) | 1.9 |
| Niacin (mg/100 g) | 12.7 |
| Calcium (mg/100 g) | 425.8 |
| Iron (mg/100 g) | 14.4 |

For grains and beans, as illustrated in Table 10, the food product may contain twice as much oats, black bean, brown rice, sorghum as buckwheat, millet, mung bean, red bean, and sesame seed. The amount of flax seed may vary. Alternatively, as illustrated in Table 11, the food product may contain twice as much adlay, barley, black bean, brown rice, sorghum as buckwheat, millet, mung bean, red bean, and sesame seed. Alternatively, as illustrated in Table 12, the food product may contain twice as much oats, black bean, brown rice, sorghum as buckwheat, millet, mung bean, red bean, and sesame seed. The amount of flax seed may vary. Similar to Table 8, the ratio of ingredients shown in Tables 10, 11, and 12 may be approximate and may vary. The food product may also contain an additive, which may be a preservative.

TABLE 10
Ratio of Ingredients based on Weight (Grain and Bean)

| Ingredients | Ratio |
|---|---|
| Oats | 2 |
| Flax seed | 0.2-2 |
| Black bean | 2 |
| Brown rice | 2 |
| Buckwheat | 1 |
| Millet | 1 |
| Mung bean | 1 |
| Red bean | 1 |
| Sesame seed | 1 |
| Sorghum | 2 |

TABLE 11
Ratio of Ingredients based on Weight (Grain and Bean)

| Ingredients | Ratio |
|---|---|
| Adlay | 2 |
| Barley | 2 |
| Black bean | 2 |
| Brown rice | 2 |
| Buckwheat | 1 |
| Millet | 1 |
| Mung bean | 1 |
| Red bean | 1 |
| Sesame seed | 1 |
| Sorghum | 2 |

TABLE 12
Ratio of Ingredients based on Weight (Grain and Bean)

| Ingredients | Ratio |
|---|---|
| Adlay | 2 |
| Oats | 2 |
| Black bean | 2 |
| Brown rice | 2 |
| Buckwheat | 1 |
| Millet | 1 |
| Mung bean | 1 |
| Red bean | 1 |
| Sesame seed | 1 |
| Sorghum | 2 |

According to an embodiment of the present invention, the food product of Table 11 has the chemical nutrition facts in Table 13. Table 13 shows the nutrition facts for 100 g. One serving size of the grain product is 60 g, so the nutrition facts for one serving in Table 13 should be appropriately adjusted.

TABLE 13
Chemical Nutrition Facts of Grain and Bean Powder

| | |
|---|---|
| Calorie (kcal) | 420.9 |
| Carbohydrate (%) | 68.7 |
| Sugars (%) | 1.3 |
| Crude protein (%) | 18.3 |
| Crude fat (%) | 8.1 |
| Saturated fatty acid | 0.0 |
| (g/100 g) | |
| Trans fat (g/100 g) | 0.00 |
| Cholesterol (mg/100 g) | 1.9 |
| Sodium (mg/100 g) | 4.7 |
| Vitamin A (μg/100 g) | 9 |
| Vitamin B1 (mg/100 g) | 0.1 |
| Vitamin B2 (mg/100 g) | 0.1 |
| Vitamin B6 (mg/100 g) | 0.0 |
| Vitamin C (mg/100 g) | 4.3 |
| Vitamin E (mg/100 g) | 1.5 |
| Niacin (mg/100 g) | 0.7 |
| Calcium (mg/100 g) | 156.1 |
| Iron (mg/100 g) | 5.0 |

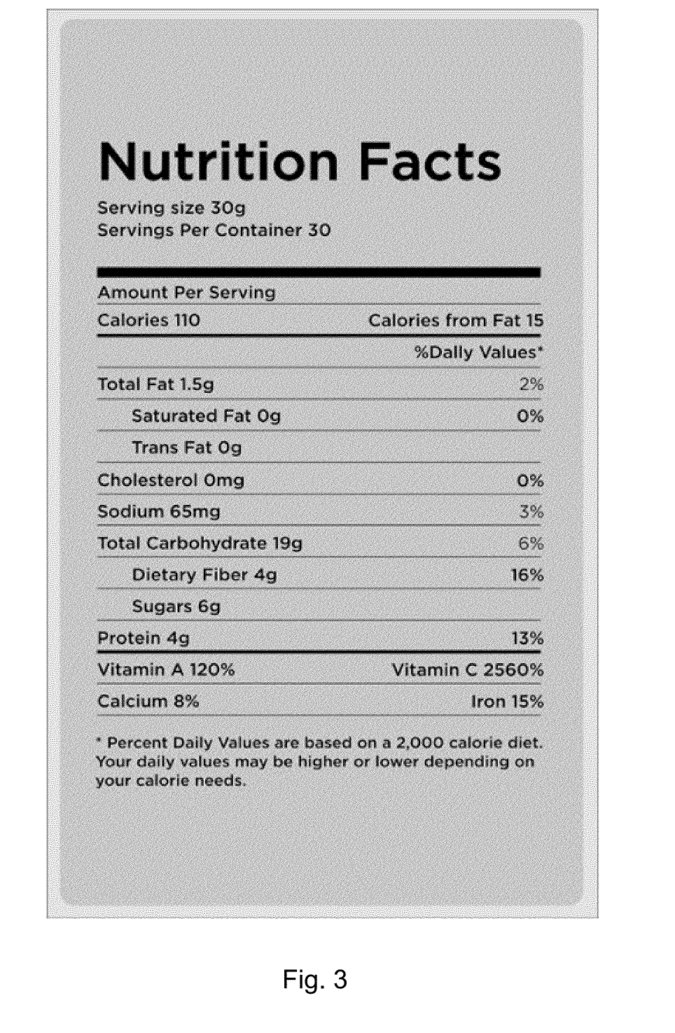

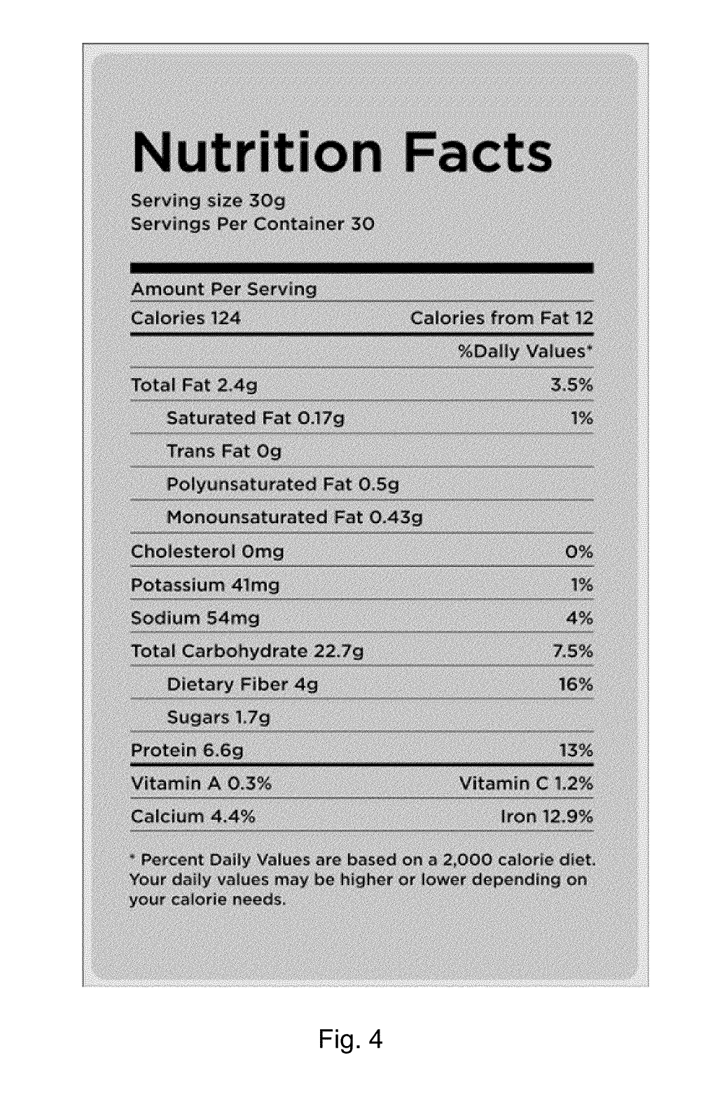

FIG. 3 provides example chemical nutrition facts of the vegetable product. FIG. 4 provides example chemical nutrition facts of the grain and bean product.

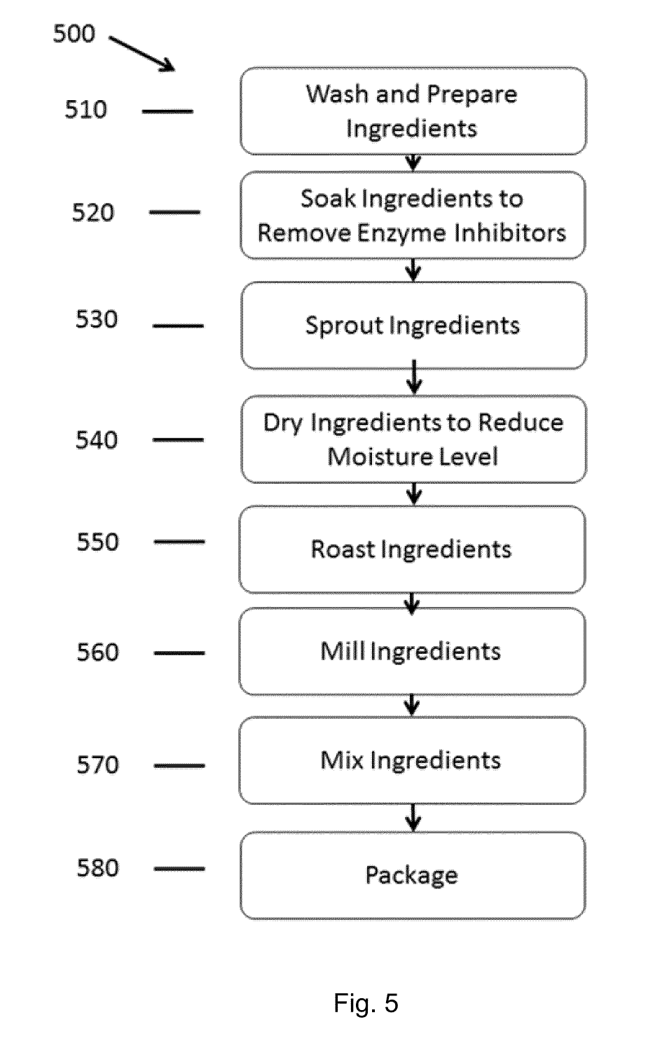

Example processes of preparing the food products are provided. The preparation process can be automated using machines or done manually. FIG. 5 illustrates example process 500 of preparing the vegetable food product. In step 510, ingredients may be washed and prepared for next steps. In step 520, the ingredients are soaked to remove enzyme inhibitors. In step 530, the ingredients are sprouted to enhance nutrient availability. In step 540, the ingredients may be dried to reduce moisture. For example, the ingredients may be dried to 5% or lower moisture level. In step 550, the ingredients may be roasted. In step 560, the ingredients may be milled. In step 570, the ingredients mixed based on a formula (e.g., ratio in Table 8). In step 560, the mixed ingredients may be packaged.

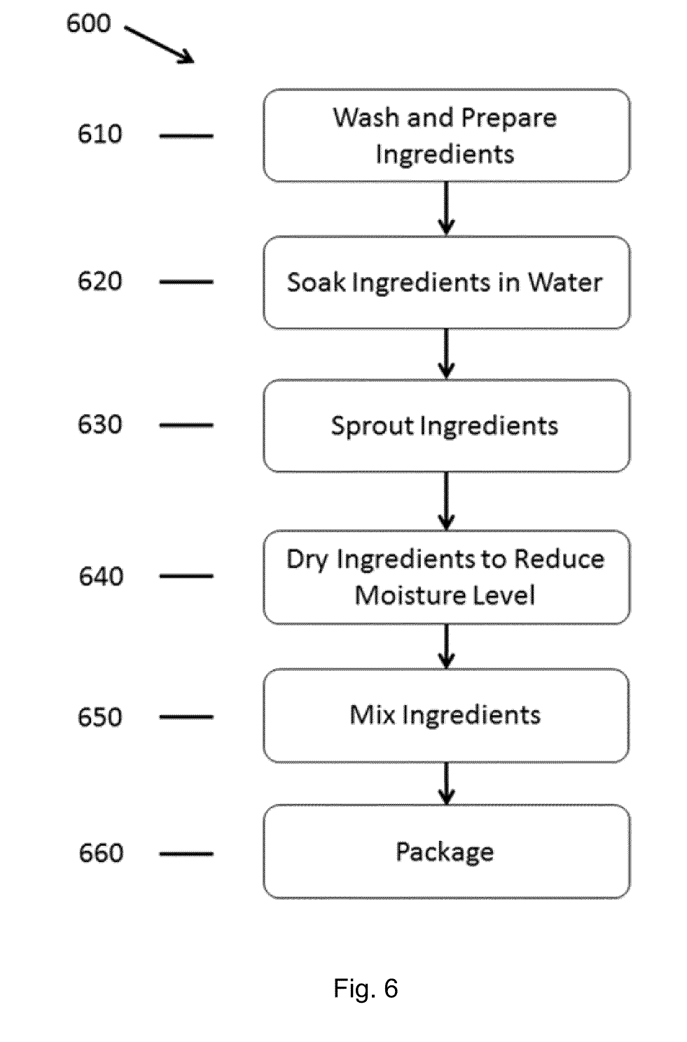

FIG. 6 illustrates example process 600 of preparing the grain and bean food product. In step 610, ingredients may be washed and prepared for next steps. In Step 620, the ingredients may be soaked in water. In step 630, some or all of the ingredients may be sprouted. For example, all grain ingredients may be sprouted. In step 640, the ingredients may be dried to reduce moisture. For example, the ingredients may be dried to 5% or lower moisture level. In step 650, the ingredients may be mixed based on a formula (e.g., ratio in Table 9). In step 660, the mixed ingredients may be packaged.

The disclosed embodiments discussed the vegetable product and the grain and bean product as two separate products. These two products may be designed to be consumed together, but packaged separately for convenience. These two products may be packaged and sold separately or packaged separately and sold together. Because the amount of serving size of the grain product (60 mg) is twice as large as the serving size of vegetable product (30 mg), the package for the grain product may contain a larger amount.

In other embodiments, the vegetable product and the grain and bean product may be combined into one product. In other embodiments, some, but not all, of the ingredients of the two products may be combined. In further embodiments, there may be more than two products containing a different set of ingredients. For example, one product may only include some grains, and another product may include beans.

For example, all or some of the ingredients in Table 8 and Table 10, 11, or 12 may be put in one food product. The combined ingredients of the grain and bean products may be twice as much as the combined ingredients of the vegetable product, as illustrated in Table 14, 15, or 16. As indicated above, the ratio may not be exact for the combined product. In addition, ascorbic acid can be added approximately equal amount of the almond, carrot, and garlic.

TABLE 14
Ratio of Ingredients based on Weight (Combined Product)

| Ingredients | Ratio |
|---|---|
| Almond | 1 |
| Broccoli | 2 |
| Cabbage | 2 |
| Carrot | 1 |
| Corn Silk | 2 |
| Garlic | 1-2 |
| Onion | 2 |
| Spinach | 2 |
| Sweet Potato | 2 |
| Tomato | 2 |
| Oats | 4 |
| Flax seed | 0.4-4 |
| Black bean | 4 |
| Brown rice | 4 |
| Buckwheat | 2 |
| Millet | 2 |
| Mung bean | 2 |
| Red bean | 2 |
| Sesame seed | 2 |
| Sorghum | 4 |

TABLE 15
Ratio of Ingredients based on Weight (Combined Product)

| Ingredients | Ratio |
|---|---|
| Almond | 1 |
| Broccoli | 2 |
| Cabbage | 2 |
| Carrot | 1 |
| Corn Silk | 2 |
| Garlic | 1-2 |
| Onion | 2 |
| Spinach | 2 |
| Sweet Potato | 2 |
| Tomato | 2 |
| Adlay | 4 |
| Barley | 4 |
| Black bean | 4 |
| Brown rice | 4 |
| Buckwheat | 2 |
| Millet | 2 |
| Mung bean | 2 |
| Red bean | 2 |
| Sesame seed | 2 |
| Sorghum | 4 |

TABLE 16
Ratio of Ingredients based on Weight (Combined Product)

| Ingredients | Ratio |
|---|---|
| Almond | 1 |
| Broccoli | 2 |
| Cabbage | 2 |
| Carrot | 1 |
| Corn Silk | 2 |
| Garlic | 1-2 |
| Onion | 2 |
| Spinach | 2 |
| Sweet Potato | 2 |
| Tomato | 2 |
| Adlay | 4 |
| Oat | 4 |
| Black bean | 4 |
| Brown rice | 4 |
| Buckwheat | 2 |
| Millet | 2 |
| Mung bean | 2 |
| Red bean | 2 |
| Sesame seed | 2 |
| Sorghum | 4 |

The disclosed embodiments are provided for illustrative purposes only. While specific configurations of the food product have been described, it is understood that the present invention can be modified. There are many alternative ways of producing the food product.

1. A self balancing food product comprising a substance:
wherein the substance is prepared from a plurality of ingredients selected to balance internal organs of a body,
wherein each of the internal organs is supported by at least one of the plurality of ingredients.

2. The food product according to claim 1, wherein the substance is prepared from the plurality of ingredients by a process comprising the steps of:
soaking the plurality of ingredients;
sprouting the plurality of ingredients; and
drying the plurality of ingredients.

3. The food product according to claim 2, wherein the food product has a formula selected from the group consisting of powder, bar and liquid.

4. The food product according to claim 1, wherein the internal organs comprise five major organs and six supporting organs.

5. The food product according to claim 4, wherein the plurality of ingredients is selected from a group consisting of a vegetable and a grain,
wherein the vegetable is one or more vegetables selected from a group consisting of broccoli, cabbage, spinach, tomato, sweet potato, carrot, onion, garlic, almond and corn silk, and
wherein the grain is one or more grains selected from a group consisting of brown rice, barley, sorghum, adlay, black bean, millet, buckwheat, red bean, mung bean, oats, flax seed, and sesame seed.

6. The food product according to claim 5, wherein the vegetable is five or more vegetables and the grain is five or more grains.

7. The food product according to claim 5, wherein the substance consists of a vegetable, and the vegetable comprises broccoli, cabbage, spinach, tomato, sweet potato, carrot, onion, garlic, almond and corn silk.

8. The food product according to claim 5, wherein the substance consists of a grain, and the grain comprises brown rice, oats, sorghum, adlay, black bean, millet, buckwheat, red bean, mung bean and sesame seed.

9. A self balancing food product comprising a substance selected from the group consisting of a vegetable and a grain,
wherein the vegetable is one or more vegetables selected from the group consisting of broccoli, cabbage, spinach, tomato, sweet potato, carrot, onion, garlic, almond and corn silk, and
wherein the grain is one or more grains selected from the group consisting of brown rice, barley, sorghum, adlay, black bean, millet, buckwheat, red bean, mung bean, oats, flax seed, and sesame seed.

10. The food product according to claim 9, wherein the substance comprises 5 or more of the substances selected from the group consisting of a vegetable and a grain.

11. The food product according to claim 10, wherein the substance comprises 10 or more of the substances selected from the group consisting of a vegetable and a grain.

12. The food product according to claim 9, wherein the substance consists of a vegetable, and the vegetable comprises broccoli, cabbage, spinach, tomato, sweet potato, carrot, onion, garlic, almond and corn silk.

13. The food product according to claim 12, wherein the almond, broccoli, cabbage, carrot, corn silk, garlic, onion, spinach, sweet potato and tomato are comprised in a ratio of 1:2:2:1:2:1:2:2:2:2 by weight.

14. The food product according to claim 9, wherein the substance consists of a grain, and the grain comprises brown rice, sorghum, black bean, millet, buckwheat, red bean, mung bean and sesame seed.

15. The food product according to claim 14, wherein the black bean, brown rice, buckwheat, millet, mung bean, red bean, sesame seed and sorghum are comprised in a ratio of 2:2:1:1:1:1:1:2 by weight.

16. The food product according to claim 14, wherein the grain further comprises at least one of barley, oat, adlay, and flax seed.

17. A method of making a self balancing food, the method comprising:
selecting a plurality of internal organs of a body;
selecting a plurality of ingredients to balance the plurality of internal organs, wherein each of the plurality of internal organs is supported by at least one of the plurality of ingredients.

18. The method according to claim 17, further comprising:
soaking the plurality of ingredients;
sprouting the plurality of ingredients; and
and drying the plurality of ingredients.

19. The method according to claim 18, wherein the plurality of ingredients is selected from a group consisting of a vegetable or a grain,
wherein the vegetable is one or more vegetables selected from a group consisting of broccoli, cabbage, spinach, tomato, sweet potato, carrot, onion, garlic, almond and corn silk, and
wherein the grain is one or more grains selected from a group consisting of brown rice, barley, sorghum, adlay, black bean, millet, buckwheat, red bean, mung bean, oats, flax seed, and sesame seed.

20. The method according to claim 19, wherein the vegetable is five or more vegetables and the grain is five or more grains.
